(19) United States
(12) Patent Application Publication
(10) Pub. No.: US 2008/0183626 A1
(43) Pub. Date: Jul. 31, 2008

(54) Software license agreement management based on temporary usage

(76) Inventors: Francisco Romero, Richardson, TX (US); Michael James Guerette, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/701,295

(22) Filed: Jan. 31, 2007

(51) Int. Cl. H04L 9/00

(52) U.S. Cl. 705/59

(57) ABSTRACT

A computer-automated system manages license agreements in a server that is partitioned into multiple partitions including physical partitions and/or virtual partitions operative in separate operating environments executing independent operating system and applications with resources dynamically allocated among the multiple partitions. A licensed software element is executed on the dynamically-allocated resources and charges are assessed based on execution of the licensed software element on the dynamically-allocated resources.

### BACKGROUND

Software is licensed using a variety of licensing schemes, some based on hardware considerations such as per server tier, per tier or per processor, or another consideration such as number of concurrent users, for example. In general software licenses are perpetual. A client has a non-exclusive right to use the software for an extended period of time. A trend in the industry exists to define new software licensing business models based on usage.

Advanced servers enable partitioning of resources into physical partitions and virtual partitions. Physical partitions are electrically isolated and can migrate resources among other physical partitions. Physical partitions can be arranged to contain one or more virtual partitions, which are typically implemented via software or firmware operation and can also have resource migration capabilities. Various physical and virtual partitions can operate at least partly independently and run different software elements or different system software combinations with different pricing characteristics.

In complex systems, per-processor software licensing is difficult to deploy and manage because the number of processors in each partition may vary over time. Typically, such difficulties are addressed by overprovisioning the system or ignoring the problem and allowing customers work out specific solutions with software vendors.

### SUMMARY

An embodiment of a computer-automated system manages license agreements in a server that is partitioned into multiple partitions. The partitions include physical partitions and/or virtual partitions that are operative in separate operating environments executing independent operating system and applications with resources dynamically allocated among the partitions. A licensed software element is executed on the dynamically-allocated resources and charges are assessed based on execution of the licensed software element on the dynamically-allocated resources.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an embodiment of a computer-automated system that manages license agreements in a server;

FIG. 2 is a schematic block diagram showing an embodiment of a server that is configured with software licensing support;

FIGS. 3A through 3D are a set of flow charts that depict aspects of one or more embodiments of a method for monitoring and/or enforcing a software licensing agreement; and

FIGS. 4A and 4B show a schematic block diagram and software licensing tool initialization table that are illustrative of operation of an embodiment of a temporary software licensing system.

### DETAILED DESCRIPTION

A temporary software license is disclosed that better reflects advances in virtualization, utility computing, and dynamic server environments.

A temporary software license is defined that can be used in a virtualized environment. Various executable constructs can be used to implement the temporary software license, and monitor for compliance with the license.

In various embodiments, illustrative temporary software license concepts and constructs enable evolution from per-processor software licensing to an approach that is reflective of partitionable or virtualized servers in which the number of processors changes over time.

An enterprise server may be partitioned into multiple partitions, such as physical partitions or virtual partitions. An individual partition represents a unique operating environment, running an individual copy of an operating system and applications. Functionally, the partitions behave like independent servers. Resources allocated to each partition can, however, vary over time, dynamically and while the partitions are running. For example a processor or memory can be migrated across two partitions for load balancing. The dynamic nature of partitionable servers presents a challenge to traditional, node-locked, per-processor based software licensing models. The problem is to be able to license software on a per-processor basis when the number of processors changes over time. One solution is to require software licenses to cover the largest possible number of processors that a partition may contain, resulting in significant cost overhead since in many cases processors can only exist in one partition at a time and the maximum number is not realizable across partitions. If all partitions are running the same software, then licensing for the total number of physical processors is appropriate. However, when different software products are running in different partitions, as is frequently the case, a more flexible mechanism, for example the illustrative temporary software license can be used to enable licensing on a temporary basis, for example when the partition uses more processors than baseline.

In an illustrative temporary software license arrangement, permanent licenses can be based on the number of permanent processors on the server, and a specific distribution of those processors to different partitions on the server. The number of processors per partition may change over time as a result of processor migrations across partitions without impacting the total number of permanent processors. Also, the number of processors may increase by activating reserve processors. One example of such reserve rights is Temporary instant Capacity (TiCAP) usage rights that are made available by Hewlett Packard Company of Houston, Tex.

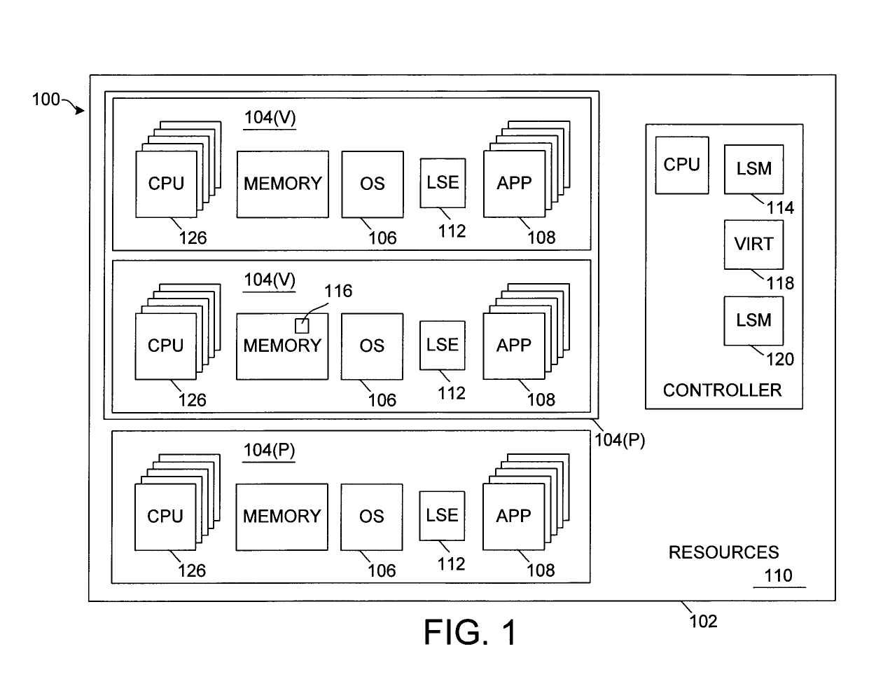

Referring to FIG. 1, a schematic block diagram illustrates an embodiment of a computer-automated system 100 that manages license agreements in a server 102 that is partitioned into multiple partitions 104. The partitions 104 include physical partitions 104P and/or virtual partitions 104V that operate in separate operating environments executing independent operating system (OS) 106 and applications 108 using resources 110 dynamically allocated among the partitions 104. A licensed software element (LSE) 112 is executed on the dynamically-allocated resources 110 and charges are assessed based on execution of the licensed software element 112 on the dynamically-allocated resources 110.

In an example temporary software deployment model, a temporary license can be implemented as a near-pure license product wherein the temporary license for a particular software product can be essentially independent of other software products such as operating system and also essentially independent of permanent licenses on the same product. For example, the licensed software element 112 that is licensed is not supplied with the temporary license. The customer responsible for installing software corresponding to the licensed software element 112 performs the installation from media using corresponding permanent license codewords. A dummy software product according to the temporary license can be shipped and installed to record a timestamp and for discovery purposes. A temporary software license becomes discoverable if the license is supplied with a dummy timestamp file. Accordingly, the software deployment model enables limitation to a single installation per complex, per group, or to other deployment unit, as desired.

The system 100 comprises a software licensing monitor (LSM) 114 that can be used to access charges for the licensed software element 112. If desired, the software licensing monitor 114 can be installed with the licensed software element 112. However, in more flexible arrangement, the software licensing monitor 114 can be implemented as a standalone product independently of installation of the licensed software element 112. An example technique for standalone deployment of the software licensing monitor 114 is usage of a dummy code 116 that is installable to record timestamp and for discovery.

The licensed software element 112 executes on the dynamically-allocated resources 110 and can be installable independently of the software licensing monitor 114 which assesses charges on execution of the licensed software element 112.

The system 100 can also include a resource virtualizer 118 that dynamically allocates the resources 110 among the multiple partitions 104 including physical partitions and/or virtual partitions operative in separate operating environments executing independent operating system and applications.

The software licensing monitor 114 can be implemented to assess charges on a per-processor basis as number of processors upon which the licensed software element executes changes over time.

In an illustrative temporary software license concept, for example a Temporary instant CAPacity for software (TiCAP-SW) concept, permanent software licenses are based on the “baseline” number of processor cores and temporary software licenses enable the number of cores to go above baseline temporarily. A temporary license enables a pay-as-you-use model for software. A virtual server environment can be implemented with flexible virtual servers and can be highly benefited by a flexible licensing concept such as temporary software licenses or TiCAP-SW. Temporary software licensing can be applied to essentially all types of software from all operating system aspects to all application aspects.

In some embodiments, the baseline state or baseline can be discovered across the complex that comprises the system 100 to determine which cores are permanently licensed.

For example, the software licensing monitor 114 can be formed to assess baseline licensing charges as a function of a selected baseline number of processors 126, for example central processing units (CPUs), executing on the server 102 and a selected distribution of the processors 126 to different partitions on the server 102. The software licensing monitor 114 then assesses temporary software licensing charges as a function of the execution time of the licensed software element 112 on processors 126 that exceed the baseline number of processors.

In one implementation, counters for the temporary software license can be incremented if and only if the number of active cores exceeds baseline so that customers receive credit for permanent licenses across partitions.

For a system 100 in which licensing charges are determined from baseline usage and temporary usage that exceeds baseline, the licensed software element 112 can be installed with baseline licensing and installable with temporary software licensing that is independent of baseline licensing.

The system 100 may include temporary license software auditing tools that can be available with an operating system distribution or by other distribution. A customer can be contractually required to maintain system compliance with the temporary software license contract. A monitoring/audit tool can be supplied to aid customer compliance. The tool can be implemented for guidance and not as a billing or enforcement tool, although more authoritative implementations such as runtime license enforcement are possible.

For example, the software licensing monitor 114 can be implemented to include or execute in cooperation with a compliance monitor (CM) 120 that monitors compliance with a licensing agreement. The compliance monitor 120 can be configured to monitor or discover several operational parameters including the number of baseline processors in the individual partitions, the number of baseline licenses per partition, and the number of temporary software licenses.

In some arrangements, the compliance monitor 120 can monitor for discovery of a timestamp for the licenses.

In a dynamic virtual environment, the number of baseline processor cores can change. The compliance monitor 120 can be configured to monitor and track changes in the number of processor cores. For example, the computer-automated system 100 can be operated in a virtual server environment (VSE) that implements instant capacity (iCAP) and temporary instant capacity (TiCAP) concepts made available by Hewlett Packard Company. Instant capacity (iCAP) systems are purchased with at least one active and a number of deactivated processors that may be permanently activated when desired. The corresponding number of licenses is to be purchased at the appropriate time for all processors. Temporary instant capacity (TiCAP) licenses temporarily activate processors for as long as the customer specified. Upon activation of the license for the operating environment installed on each TiCAP processor is automatically granted. Pay-per-use (PPU) systems are leased and all operating environment licenses on active processors are funded by the monthly leasing agreement.

In the VSE environment, the number of baseline number of cores is modified by activation of a TiCAP core, load-balancing iCAP usage rights across partitions, load-balancing iCAP usage rights across servers, migrating a core across two virtual partitions, dynamically changing the number of virtual CPUs in a virtual machine (VM) guest, dynamically moving a cell across partitions, dynamically moving a cell usage right across servers in a global instant capacity (GiCAP) configuration, and the like.

In some embodiments, the compliance monitor 120 can be implemented to monitor changes in the number of processors and the balance of temporary software license execution in comparison to baseline execution. The compliance monitor 120 can communicate a notification or warning as balances near or exceed exhaustion.

The compliance monitor 120 can be configured to detect resource activation and/or migration and monitor compliance with the software licensing agreement when a resource is activated or migrates. The compliance monitor 120 can be configured to enforce compliance with the licensing agreement.

The illustrative temporary software license can be called Temporary instant Capacity for Software (TiCAP-SW). TiCAP-SW enables a per-processor software license for a predefined duration, for example 30 processor-days. Unlike perpetual licenses, a TiCAP-SW can be limited to validity only for the license duration. The licensing model enables consumption of TiCAP-SW licenses to occur over an extended period of time by supporting activation/deactivation of the license. Activation and deactivation can occur automatically when the number of processors on a system changes, for example activating when the processor number exceeds a baseline number and deactivating when the processor number falls below baseline. Tracking of TiCAP-SW enables an increase or maximization of licensed software utilization.

A Temporary instant Capacity for Software (TiCAP-SW) license can be specified to apply to a software product for a number of processor hours or minutes. The license enables a user to license the software for the baseline number of processors and then use the TiCAP-SW license to account for above-baseline periods. Accordingly, the user only provisions for the baseline and can use a pay-as-you-go model for times when the number of processors increases above the baseline.

Using temporary software licenses, a software license portfolio can be based on a baseline number of processors defined by capacity planning activities. Provisioning of software licenses can be implemented for the baseline and not for the maximum number, thereby enabling customer cost savings.

Temporary software licenses can enable financial and accounting benefits since customers can use expense dollars to purchase a temporary license such as TiCAP-SW rather than highly critical capital dollars.

Application of TiCAP-SW balances can be deployed at the server level or at the group level, or even across multiple datacenters, to enable higher flexibility in software acquisition.

Temporary software licensing enables higher flexibility than perpetual licensing, without removing the capability of perpetual licensing for baseline hardware.

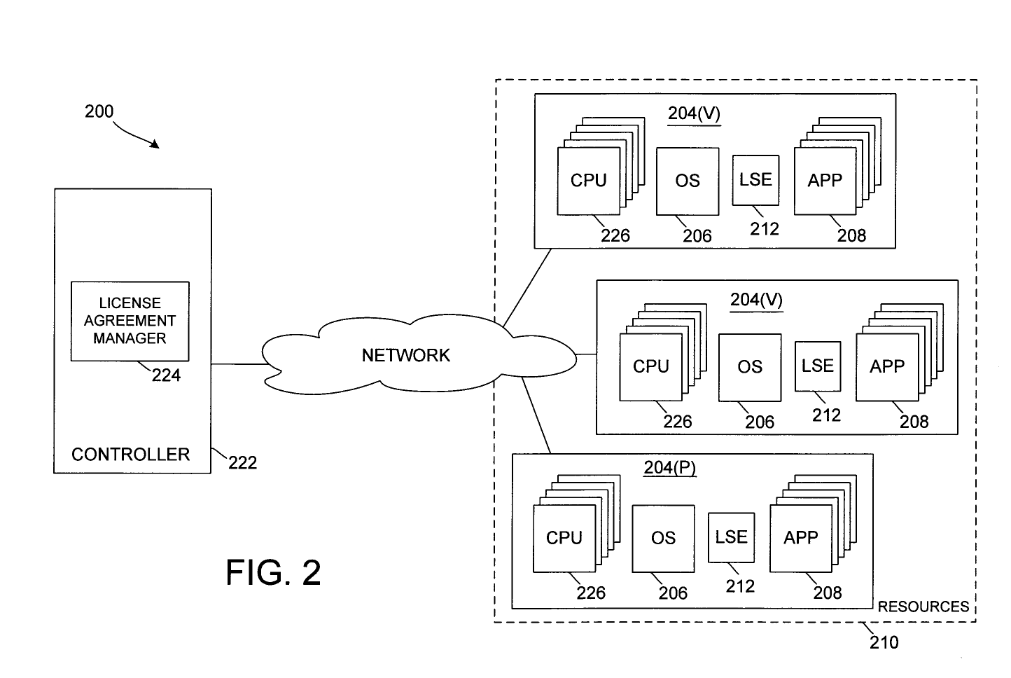

Referring to FIG. 2, a schematic block diagram illustrates an embodiment of a server 200 that is configured with software licensing support. The server 200 comprises a plurality of resources 210 and a controller 222 configured for partitioning the server 200 into multiple partitions 204 including physical partitions 204P and/or virtual partitions 204V that operate in separate operating environments executing independent operating systems 206 and applications 208. The controller 222 dynamically allocates the resources 210 among the multiple partitions 204. The server 200 further comprises a licensed software element 212 that executes on the dynamically-allocated resources 210. An executable license agreement manager 224 assesses charges based on execution of the licensed software element 212 on the dynamically-allocated resources 210.

In an illustrative embodiment, the server 200 can implement a temporary software licensing model by assessing charges for software executing on baseline processor cores and also for execution of the software on processor cores that are available temporarily. A baseline number of processor cores is defined as the number of fully-owned cores on the server 200. The baseline number varies over time as a customer buys more processors or permanently activates instant capacity (iCAP) right-to-use (RTU).

In an example software licensing model, permanent licenses can be required for baseline processor cores, for example Enterprise Operating Environment (OEO) and Virtual Server Environment (VSE) can be licensed for a specific number of processor cores. If the number of cores is greater than the baseline number B at any point in time, then temporarily software licenses (TiCAP-SW) enable software to be used, for example EOE and VSE Suite TiCAP licenses are imposed.

In an example model, the TiCAP-SW license applies to an entire server complex, including all the partitions in the manner of hardware TiCAP.

TiCAP-SW can be made available with a selected unit of purchase, for example 30-core-days per license with a unit of activation of 30 minutes, although a particular model may allow any suitable number of purchase units.

Some temporary software license models can specify that a temporary license is only available if a corresponding permanent or baseline license is also purchased. For example, at lease one permanent license per partition can be required before TiCAP-SW can be applied to a complex.

The executable license agreement manager 224 can be formed to assess baseline licensing charges as a function of a selected baseline number of processors 226 on the server 200 and a selected distribution of the processors 226 to different partitions 204 on the server 200. The license agreement manager 224 also assesses temporary software licensing charges as function of time of execution of the licensed software element 212 on processors 226 that exceed the baseline number of processors 226.

The executable license agreement manager 224 can be configured for monitoring compliance with a licensing agreement by discovering baseline processors in individual partitions, baseline licenses per partition, and temporary software licenses.

In some embodiments, the executable license agreement manager 224 can be configured for monitoring a balance of processors executing software under a temporary software license in relation to baseline, and communicating a notification as balances near or exceed exhaustion.

The executable license agreement manager 224 can be implemented to detect resource activation and/or migration and monitor compliance with a licensing agreement at the occurrence of resource activation and/or migration. The license agreement manager 224 can then enforce compliance with the licensing agreement.

In an example embodiment, enforcement can be imposed at the hardware activation/migration level so that operations that change hardware would seek authorization from the license agreement manager 224, for example via application programming interface (API). If temporary software license balances are not available, operations such as instant capacity (iCAP) activation, virtual partition migration or physical partition migration can be blocked.

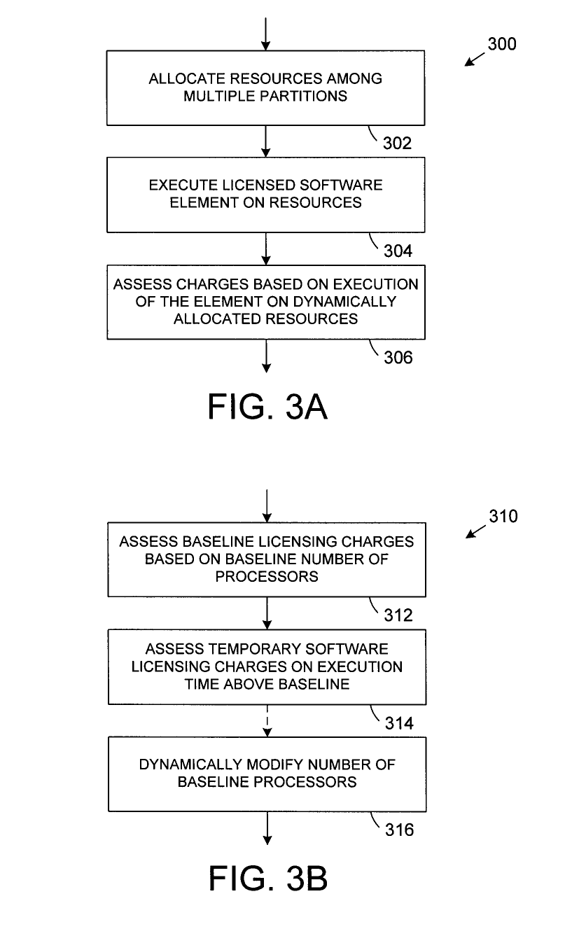

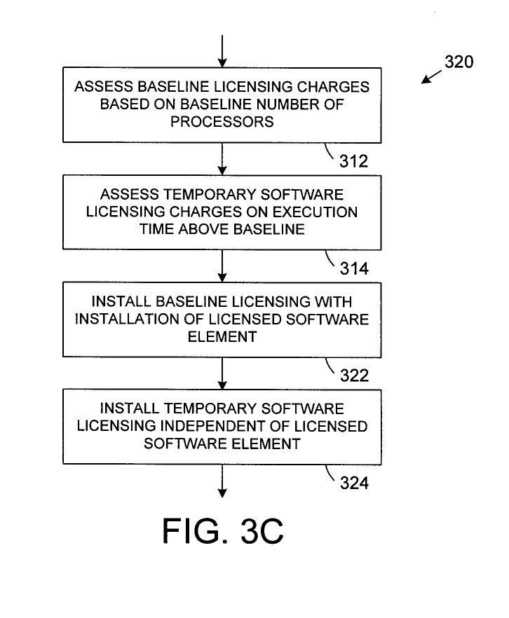

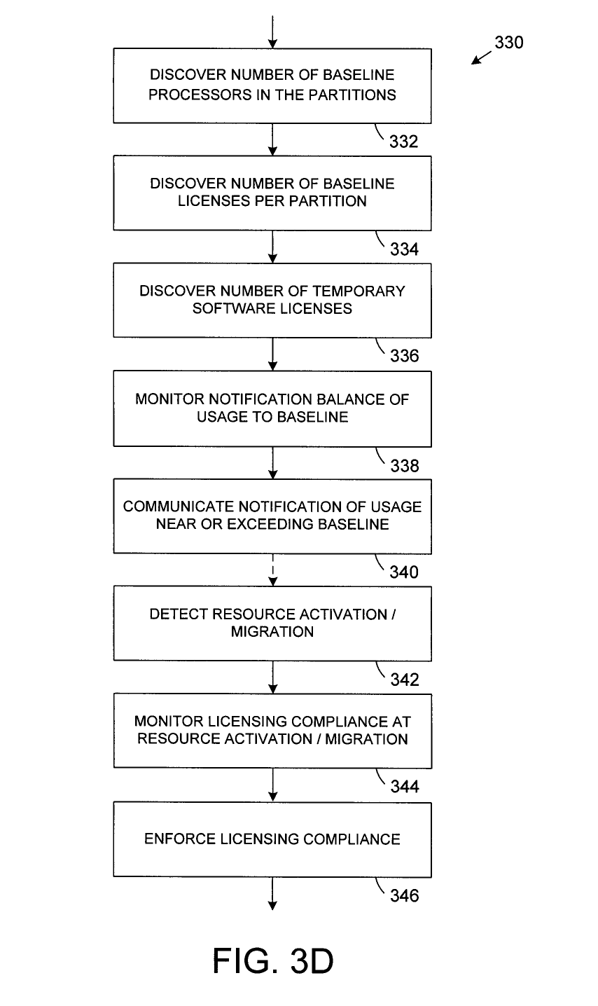

Referring to FIGS. 3A through 3D, a set of flow charts depict aspects of one or more embodiments of a method for monitoring and/or enforcing a software licensing agreement. FIG. 3A shows an embodiment of a computer-automated method 300 for managing a software license agreement comprising dynamically allocating 302 resources among multiple partitions including physical partitions and/or virtual partitions that can be operative in separate operating environments and execute in independent operating systems and applications. A licensed software element is executed 304 on the dynamically-allocated resources. Charges are assessed 306 on a basis of execution of the licensed software element on the dynamically-allocated resources.

In some embodiments, charges can be assessed on a per-processor basis as number of processors upon which the licensed software element executes changes over time.

Referring to FIG. 3B, in a particular example embodiment method 310 baseline licensing charges can be assessed 312 on the basis of a selected baseline number of processors on the server and a selected distribution of the processors to different partitions on the server. Temporary software licensing charges can be assessed 314 on the basis of execution time of the licensed software element on processors above the baseline number of processors.

In some embodiments, the number of baseline processors can be dynamically modified 316.

For example, referring to FIG. 3C, an embodiment of a method 320 for managing a software licensing model can further comprise installing 322 baseline licensing with the licensed software element, and installing 324 temporary software licensing into the server independent from installation of the licensed software element.

Referring to FIG. 3D, an embodiment of a method 330 for monitoring compliance with a licensing agreement can comprise discovering 332 the number of baseline processors in individual partitions, discovering 334 the number of baseline licenses per partition, and discovering 336 the number of temporary software licenses. The balance of temporary software license usage in comparison to baseline usage can be monitored 338 and notification can be communicated 340 when the balances near or exceed exhaustion.

Monitoring can also include discovery of timestamps for licenses, whereby the temporary license can be activated.

In some embodiments, the compliance monitoring method 330 can further comprise detecting 342 resource activation and/or migration. Compliance with a licensing agreement upon a condition of resource activation and/or migration can be monitored 344 and enforced 346.

In an illustrative example, the method depicted in FIGS. 3A through 3D can be supplied in multiple temporary licensing software components. A first component can be part of operating system software for the operating environment in which the software subject to the temporary license runs. A customer can use permanent licenses to install the licensed software from media. In the illustrative example, the temporary license is not included with a permanent license for the same software.

A second component is a temporary software manager that installs a dummy timestamp file that is used for discovery. A single copy of the temporary software manager is sufficient for installation on the complex rather than one copy per partition. New or additional temporary software licenses can require installation of a new software bundle.

A third component is a license monitoring tool bundle. A single installation for a complex, data center, or other environment is sufficient for the audit/monitoring tool.

The monitoring/auditing tool can be implemented to enable an honest customer to stay honest without any enforcement or can be configured with enforcement capability. The monitoring/auditing tool can be implemented as “Temporary Operating Environment” (TOE) agents to enable complex-wide or server-group-wide operation.

Input parameters to the monitoring/auditing tool can include a system configuration table that specifies the number of baseline cores in each partition, and the number of permanent licenses per partition, all of which are discoverable. The input parameters also include the number of temporary software licenses on complex, and a start timestamp for each license which are also discoverable. Output parameters of the monitoring/auditing tool can include a decrement balance for each temporary software license as different partitions using each temporary license pass above the complex baseline. Another output parameter is email notification as balances approach or exceed exhaustion.

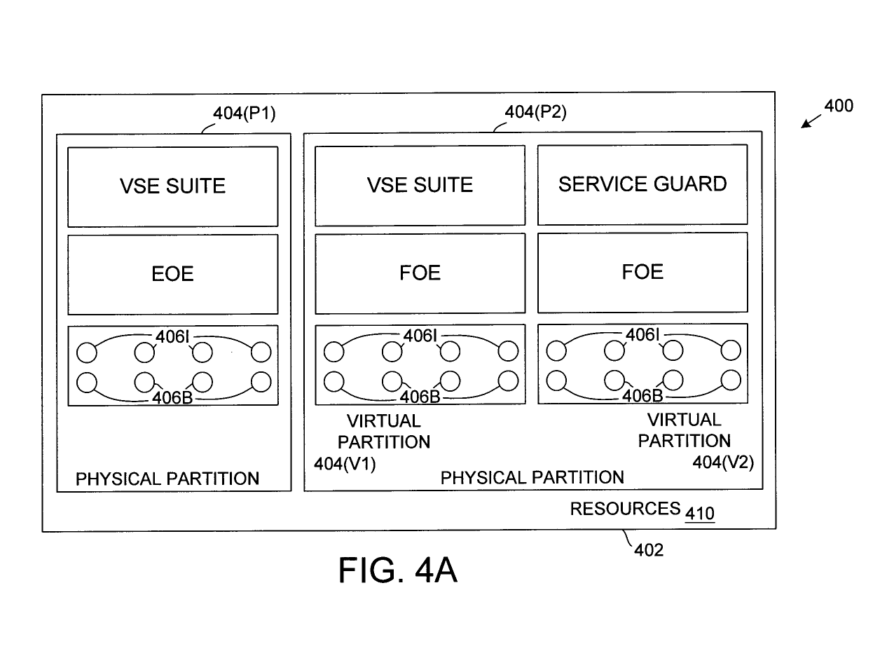

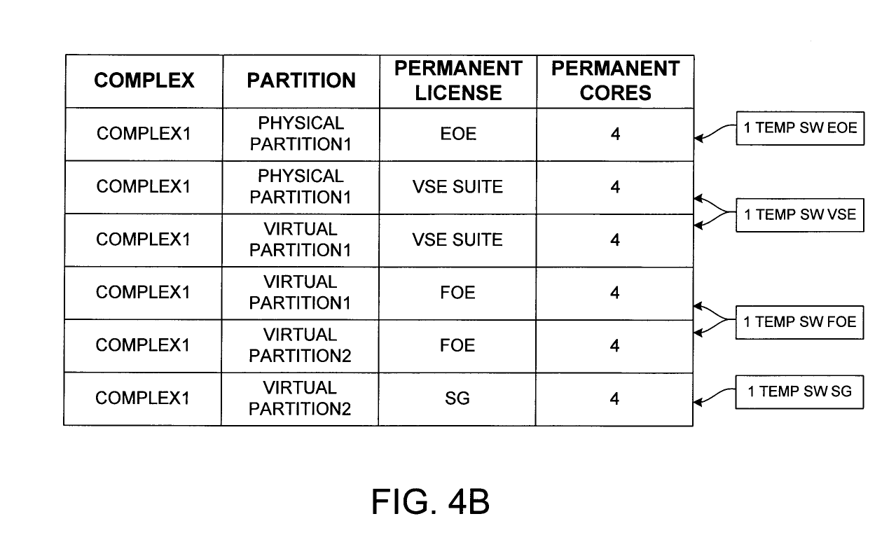

Referring to FIG. 4A and 4B, a schematic block diagram and software licensing tool initialization table are illustrative of operation of an embodiment of a temporary software licensing system. FIG. 4A illustrates resources 410 in a system 400 including a server 402 that is partitioned into multiple partitions 404. The example partitions 404 include a first physical partition 404P1, and a second physical partition 404P2 that is further partitioned into first 404V1 and second 404V2 virtual partitions. The illustrative example shows a sophisticated server line with a large number of processors, typically 8-128 or more processors that can be virtualized. The servers can also be flexibly partitioned so the size and number of processors can be resized, thereby creating a problem for software licensing that is based on usage of the software on a known number of processors.

For example purposes only, the first physical partition 404P1 executes in a virtual server environment (VSE) suite in an Enterprise Operating Environment (EOE) that is configured for application such as database application servers and logic servers. The first virtual partition 404V1 runs the VSE suite in a Foundation Operating Environment (FOE) formed for usage on Web servers, content servers, and front-end servers and has a subset of the features of the EOE. The second virtual partition 404V2 runs ServiceGuard (SG) software in the FOE for protecting mission-critical applications from a wide variety of hardware and software failures. Each of the first physical partition 404P1, the first virtual partition 404V1, and the second virtual partition 404V2 illustratively has a maximum of eight processors. The example configuration complex includes 24 processors distributed through the partitions 404 including 12 baseline processors 406B and 12 instant capacity (iCAP) processors 406I.

The system 400A, when not using temporary software licensing, would be bound to operate under a permanent EOE license for a maximum of 8 processors, a permanent FOE license for a maximum of 16 processors, a permanent VSE Suite license for a maximum of 16 processors, and a permanent SG license for a maximum of 8 processors. In contrast, for a system that implements temporary software licensing, the permanent licenses would be based on the baseline processors, specifically four processors for EOE, eight for FOE, eight for VSE Suite, and four for SG. In addition, the system would use a minimum of one temporary EOE license, one temporary FOE license, one temporary VSE suite license, and one temporary SG license. The temporary licenses are activated whenever the number of processors increases above baseline. The benefit is that less expensive temporary licenses can replace more expensive permanent licenses for situations where the number of processors per partition exceeds baseline.

FIG. 4B shows a temporary software licensing tool initialization table that can be used to deploy the temporary capacity processors.

The concept of temporary software licensing extends flexibility beyond hardware that is licensed on a temporary basis and software that is licensed on a unit basis.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer-automated method for managing a software license agreement comprising:
dynamically allocating resources among multiple partitions including physical partitions and/or virtual partitions operative in separate operating environments executing independent operating system and applications;
executing a licensed software element on the dynamically-allocated resources; and
assessing charges on a basis of execution of the licensed software element on the dynamically-allocated resources.

2. The method according to claim 1 further comprising:
assessing the charges on a per-processor basis as number of processors upon which the licensed software element executes changes over time.

3. The method according to claim 1 further comprising:
assessing baseline licensing charges on a basis of a selected baseline number of processors on the server and a selected distribution of the processors to different partitions on the server; and
assessing temporary software licensing charges on a basis of execution of the licensed software element for time on processors above the baseline number of processors.

4. The method according to claim 3 further comprising:
dynamically modifying the number of baseline processors.

5. The method according to claim 3 further comprising:
installing baseline licensing with the licensed software element; and
installing temporary software licensing into the server independent from installation of the licensed software element.

6. The method according to claim 1 further comprising:
monitoring compliance with a licensing agreement comprising:
discovering a number of baseline processors in individual partitions;
discovering a number of baseline licenses per partition;
discovering a number of temporary software licenses;
discovering a timestamp for the licenses;
monitoring a balance of temporary software license usage in comparison to baseline usage; and
communicating notifications as balances near or exceed exhaustion.

7. The method according to claim 6 further comprising:
detecting resource activation and/or migration: and
monitoring compliance with a licensing agreement at the resource activation and/or migration; and
enforcing compliance with the licensing agreement.

8. An article of manufacture comprising:
a controller usable medium having a computable readable program code embodied therein for managing a license agreement in a system that partitions a server into multiple partitions including physical partitions and/or virtual partitions operative in separate operating environments executing independent operating system and applications, and dynamically allocates resources among the multiple partitions, the computable readable program code further comprising:
a code adapted to cause the controller to monitor execution of a licensed software element on the dynamically-allocated resources; and
a code adapted to cause the controller to assess charges on a basis of execution of the licensed software element on the dynamically-allocated resources.

9. The article of manufacture according to claim 8 further comprising:
the computable readable program code installable as a standalone product independently of installation of the licensed software element further comprising:
a dummy code installable to record timestamp and for discovery.

10. The article of manufacture according to claim 8 further comprising:
a code adapted to cause the controller to dynamically allocate resources among multiple partitions Including physical partitions and/or virtual partitions operative in separate operating environments executing independent operating system and applications; and
a code executable as the licensed software element on the dynamically-allocated resources and installable independently of the code adapted to cause the controller to assess charges on the licensed software element execution.

11. The article of manufacture according to claim 8 further comprising:
a code adapted to cause the controller to assess the charges on a per-processor basis as number of processors upon which the licensed software element executes changes over time.

12. The article of manufacture according to claim 8 further comprising:
a code adapted to cause the controller to assess baseline licensing charges on a basis of a selected baseline number of processors on the server and a selected distribution of the processors to different partitions on the server; and
a code adapted to cause the controller to assess temporary software licensing charges on a basis of execution of the licensed software element for time on processors above the baseline number of processors.

13. The article of manufacture according to claim 12 further comprising:
the licensed software element that is installable with baseline licensing; and
the licensed software element that is installable with temporary software licensing independent of baseline licensing.

14. The article of manufacture according to claim 8 further comprising:
a code adapted to cause the controller to monitor compliance with a licensing agreement comprising:
a code adapted to cause the controller to discover a number of baseline processors in individual partitions;
a code adapted to cause the controller to discover a number of baseline licenses per partition;
a code adapted to cause the controller to discover a number of temporary software licenses;
a code adapted to cause the controller to discover a timestamp for the licenses;
a code adapted to cause the controller to monitor a balance for the temporary software licenses as partitions using temporary software exceed baseline; and
a code adapted to cause the controller to communicate notifications as balances near or exceed exhaustion.

15. The article of manufacture according to claim 14 further comprising:
a code adapted to cause the controller to detect resource activation and/or migration; and
a code adapted to cause the controller to monitor compliance with a licensing agreement at the resource activation and/or migration; and
a code adapted to cause the controller to enforce compliance with the licensing agreement.

16. A server comprising:
a plurality of resources;
a controller configured for partitioning the server Into multiple partitions including physical partitions and/or virtual partitions operative in separate operating environments executing independent operating system and applications, and dynamically allocating the resources among the multiple partitions;
a licensed software element executable on the dynamically-allocated resources; and
an executable license agreement manager configured for assessing charges on a basis of execution of the licensed software element on the dynamically-allocated resources.

17. The server according to claim 16 further comprising:
the executable license agreement manager configured for assessing baseline licensing charges on a basis of a selected baseline number of processors on the server and a selected distribution of the processors to different partitions on the server, and assessing temporary software licensing charges on a basis of time of execution of the licensed software element on processors exceeding the baseline number of processors.

18. The server according to claim 16 further comprising:
the executable license agreement manager configured for monitoring compliance with a licensing agreement by discovering baseline processors in individual partitions, baseline licenses per partition, and temporary software licenses.

19. The server according to claim 18 further comprising:
the executable license agreement manager configured for monitoring a balance of processors executing software under a temporary software license in relation to baseline, and communicating a notification as balances near or exceed exhaustion.

20. The server according to claim 18 further comprising:
the executable license agreement manager configured for detecting resource activation and/or migration, monitoring compliance with a licensing agreement at the resource activation and/or migration, and enforcing compliance with the licensing agreement.
